(19) United States
(12) Patent Application Publication
(10) Pub. No.: US 2010/0067042 A1
(43) Pub. Date: Mar. 18, 2010

(54) Image forming apparatus and data transferring method

(76) Inventors: Junichi Ikeda, Miyagi (JP); Koji Oshikiri, Kanagawa (JP); Koji Takeo, Miyagi (JP); Tetsuya Sato, Miyagi (JP); Yosuke Kawamura, Kanagawa (JP); Hiroyuki Takahashi, Miyagi (JP)

Correspondence Address: HARNESS, DICKEY & PIERCE, P.L.C., P.O. BOX 8910, RESTON, VA, 20195, US

(21) Appl. No.: 12/461,850

(22) Filed: Aug. 26, 2009

(30) Foreign Application Priority Data
Sep. 16, 2008 (JP) 2008-236350

(51) Int. Cl. G06F 15/00

(52) U.S. Cl. 358/1.15

(57) ABSTRACT

A plotter repeats a process of standing by until the next line synchronization timing after data transfer for one line and transferring DMAC control information requesting data transfer for one line to an MCH for each line synchronization timing whereby image data for one page is transferred. Therefore, data transfer from the MCH to the plotter is processed by continuous posted requests, so that float with respect to a line period can be made longer without transmitting a plurality of data transfer requests from the plotter to the MCH in the split method. Thus, a high data transfer performance can be realized with an inexpensive circuit because the cost for mounting a buffer memory or the like on the circuit is not needed.

### CROSS-REFERENCE TO RELATED APPLICATIONS

The present application claims priority to and incorporates by reference the entire contents of Japanese Patent Application No. 2008-236350 filed in Japan on Sep. 16, 2008.

### BACKGROUND OF THE INVENTION

1. Field of the Invention

The present invention relates to an image forming apparatus.

2. Description of the Related Art

An image forming apparatus is widely used, in which a plotter for printing an image and a scanner for scanning an image are connected to a controller with a high-speed transmission path, which is a standard bus having high versatility. If the image forming apparatus is configured such that the plotter and the scanner are separately connected to the controller with a standard bus, each unit can be replaced by a new one or new unit can be added, enabling to improve extensibility in function and performance.

In recent years, various systems have been developed such as an image forming apparatus in which a standard bus is replaced by a serial transmission path (peripheral component interconnect express (PCIe)) capable of high speed transmission, which is disclosed in, for example, Japanese Patent Application Laid-open No. 2006-302250. Japanese Patent Application Laid-open No. 2006-302250 discloses a system based on the PCIe standard, in which data transfer equivalent to a memory read is performed by using a memory write request packet.

In a read transfer using a standard bus or a transmission path via a bridge, a switch, and the like, a data transfer performance is affected largely by a latency (delay time) required for a request to reach an opposite device and data to be transferred. FIG. 19 is a schematic diagram of an image forming apparatus 100 as one example of a system based on the PCIe standard. The image forming apparatus 100 includes a plotter 102 that functions as an image output unit that prints (outputs) image data on a paper sheet or the like and a scanner 103 that functions as an image input unit that acquires image data by photoelectrically scanning an image on an original. The plotter 102 and the scanner 103 are connected to a memory control hub (MCH) 109 via PCIes 104 and 106 and a switch (SW) 105. The memory control hub (MCH) 109 controls a memory 108 storing therein image data. The plotter 102 includes a plotter unit 110 and the scanner 103 includes a scanner unit 117. The MCH 109 is connected to a central processing unit (CPU) 107 and the memory 108 via a local bus. The CPU 107 controls the entire apparatus in accordance with computer programs (software) installed in the memory 108. In the image forming apparatus 100 having such configuration, great delay occurs particularly in a serial transmission path from the PCIe 104 to the SW 105 to the PCIe 106.

To solve this drawback, a split method is employed in which the next read request is issued before completion of transfer of data for a read request. The number of read requests that can be issued before completion of data transfer for the first read request is called a split number.

Because a conventional PCI bus does not respond to the split method, the split number is one. FIG. 20 is a timing chart of an operation example of performing read transfer of plotter data in an image forming apparatus, in which the split number of the read request is one. When the split number is one, as shown in FIG. 20, after a data packet transfer for one read request is completed, a single next read request is issue. Therefore, an interval by the latency required for data transfer occurs between the requests, so that data transfer efficiency is low. When a plotter operates fast and one-line period is short, or when a data amount per line is large because of high-resolution image, the data transfer cannot be completed within a line synchronization (line sync) period as shown in FIG. 20, i.e., exceeding of a period, so that an image cannot be formed appropriately.

On the other hand, PCI-X or PCIe, which is an enhanced version of PCI, responds to the split method, i.e., the split number can be set to more than one. As shown in a timing chart of FIG. 21, because the split number can be set to two, the data transfer efficiency can be improved without lengthening the period.

However, the split number needs to be set by taking into account the latency. Particularly, latency of a transmission path that passes through a switch or a bridge circuit using a serial bus such as PCIe is extremely large. Moreover, if a transmission path is shared with data transfer for other devices, such as a plotter via a scanner or a switch, the latency may change depending on various factors. Therefore, the split number cannot be determined uniquely.

Furthermore, when the split number is increased, a buffer memory is required in a data transmission path for temporarily retaining a read request and read data. Mounting a circuit responding to an excessively large split number leads to a cost increase.

According to the technology disclosed in Japanese Patent Application Laid-open No. 2006-302250, a memory write request is used for a data readout operation. Because a device that instructs the data readout issues the memory write request per address with a packet configuration as shown in FIG. 22 for performing a direct memory access (DMA) transfer. Therefore, a plurality of requests needs to be issued simultaneously in the split method in accordance with the latency from the time the memory write request arrives at the opposite device to the time data for one address is received by the memory write request. Thus, if this technology is applied to plotter data transfer in an image forming system, a problem same as that in data transfer by a typical read request occurs.

FIG. 23 is a timing chart of plotter data transfer, in which the split number is one, using the technology disclosed in Japanese Patent Application Laid-open No. 2006-302250, and a case in which the split number is two is shown in FIG. 24. In an example shown in FIG. 23, after completion of transfer of a data packet for one request, the next read request is issued. Therefore, an interval by the latency required for the data transfer occurs between the requests, so that the data transfer efficiency is low. When a plotter operates fast and one-line period is short, or when a data amount per line is large because of high-resolution image, the data transfer cannot be completed within a line sync period as shown in FIG. 23, i.e., exceeding of the period occurs, so that an image cannot be formed appropriately. If the split number is set to two as an example shown in FIG. 24, the data transfer efficiency can be improved so that exceeding of the period does not occur. However, in the above example, appropriate split number cannot be determined uniquely or a circuit to be mounted becomes large for increasing the split number.

As shown in a timing chart of FIG. 25, a read request packet is transferred to the MCH while being mixed with a write request packet of scanner data, so that the effective bandwidth of a write packet becomes narrow as the number of read requests to be issued is increased by increasing the split number.

### SUMMARY OF THE INVENTION

It is an object of the present invention to at least partially solve the problems in the conventional technology.

According to an aspect of the present invention, there is provided an image forming apparatus including an image forming unit configured to form an image based on image data; a memory configured to store therein the image data; and a memory control unit configured to control data transfer between the image forming unit and the memory. The image forming unit transmits control information to the memory control unit for obtaining the image data from the memory by using a first posted request that does not need a response from a request transmission destination. The memory control unit transfers the image data from the memory to the image forming unit by using a second posted request upon receiving the first posted request from the image forming unit.

According to another aspect of the present invention, there is provided an image forming apparatus including an image forming unit configured to form an image based on image data; a memory configured to store therein the image data; a central processing unit configured to control the image forming apparatus as a whole; a memory control unit that includes a direct memory access controller configured to allow data transfer between the image forming unit and the memory without intervention of the central processing unit; and a serial transmission path that connects the memory control unit to the image forming unit. The image forming unit, when performing image formation, transmits direct memory access controller information to the memory control unit for obtaining the image data from the memory by a posted request that does not need a response from a request transmission destination by generating a line synchronization timing with a time period that is allowed in data transfer for one line of a print image in a main-scanning direction. The memory control unit, upon receiving the direct memory access controller information from the image forming unit, retrieves the image data from the memory, and transfers the image data to the image forming unit by the posted request via the serial transmission path.

According to still another aspect of the present invention, there is provided a data transferring method including transmitting control information for acquiring image data stored in a memory from an image forming unit, which forms an image based on image data, to a memory control unit by using a first posted request that does not need a response from a request transmission destination; and transferring the image data from the memory to the image forming unit by the memory control unit by using a second posted request upon receiving the first posted request transmitted at the transmitting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration and flow of data transfer in an image forming apparatus according to a first embodiment of the present invention;

FIG. 2 is a schematic diagram of image data;

FIG. 3 is a schematic diagram illustrating a transaction in transferring the image data;

FIG. 4 is a block diagram illustrating a configuration and an operation of a plotter shown in FIG. 1;

FIG. 5 is a block diagram illustrating a configuration and an operation of a scanner shown in FIG. 1;

FIG. 6 is a block diagram illustrating a configuration and an operation of an MCH shown in FIG. 1;

FIG. 7 is a flowchart of a printing process in the plotter;

FIG. 8 is a flowchart of an image-data transfer process in the scanner;

FIG. 9 is a timing chart of an operation when transferring plotter data;

FIG. 10 is a schematic diagram illustrating printing conditions;

FIG. 11 is a block diagram illustrating an internal configuration and an operation of an MCH according to a second embodiment of the present invention;

FIG. 12 is a timing chart of an operation when transferring plotter data;

FIG. 13 is a block diagram illustrating an internal configuration and an operation of a plotter according to a third embodiment of the present invention;

FIG. 14 is a timing chart of an operation when transferring plotter data;

FIG. 15 is a timing chart of an operation example when exceeding of a line period occurs in a state where data transfer efficiency decreases;

FIG. 16 is a timing chart of an operation example when exceeding of the line period does not occur even if the data transfer efficiency decreases;

FIG. 17 is a timing chart of an example of plotter data transfer;

FIG. 18 is a timing chart of an example of a concurrent operation of the scanner and the plotter;

FIG. 19 is a block diagram of an example of a system based on the PCIe standard;

FIG. 20 is a timing chart of an operation in which a split number is one;

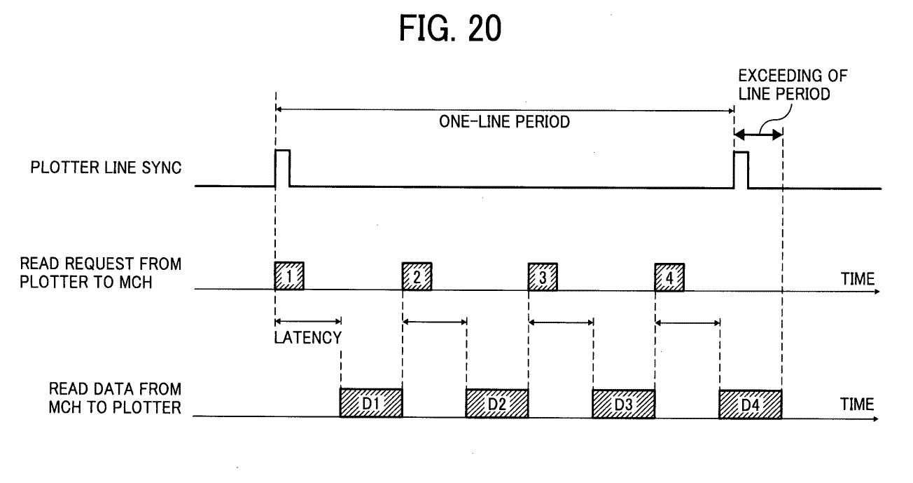

FIG. 21 is a timing chart of an operation in which the split number is two;

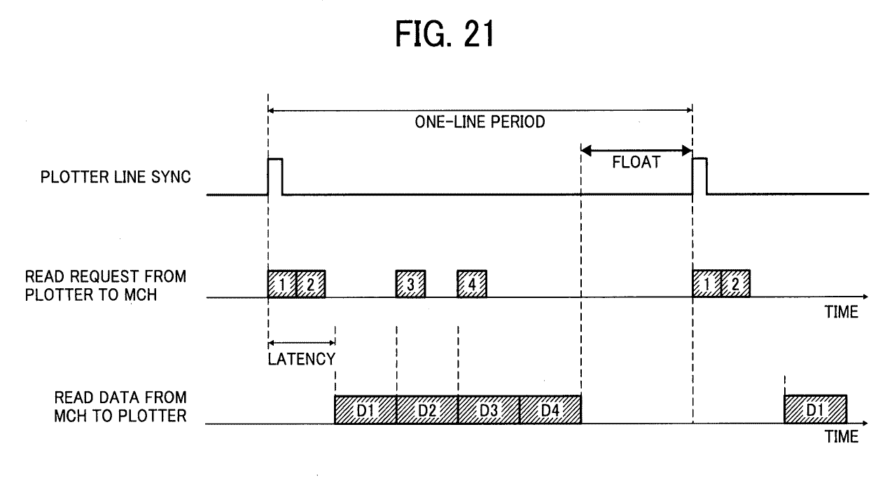

FIG. 22 is a schematic diagram of a request packet configuration;

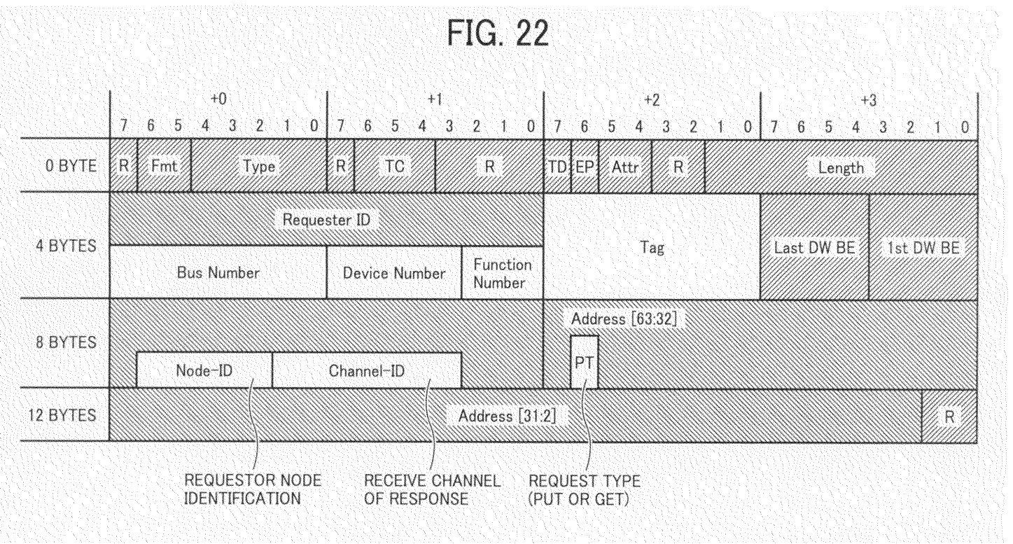

FIG. 23 is a timing chart of the plotter data transfer in which the split number is one;

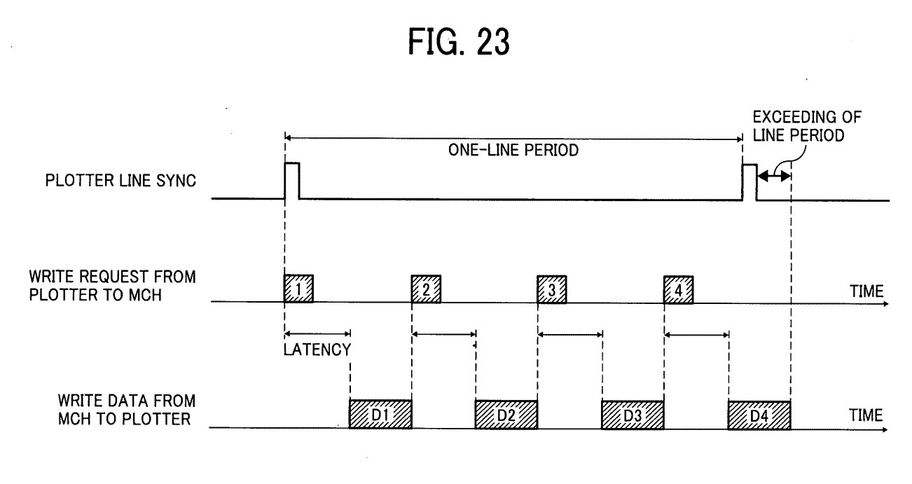

FIG. 24 is a timing chart of the plotter data transfer in which the split number is two; and

FIG. 25 is a timing chart of an example of a concurrent operation of the scanner and the plotter.

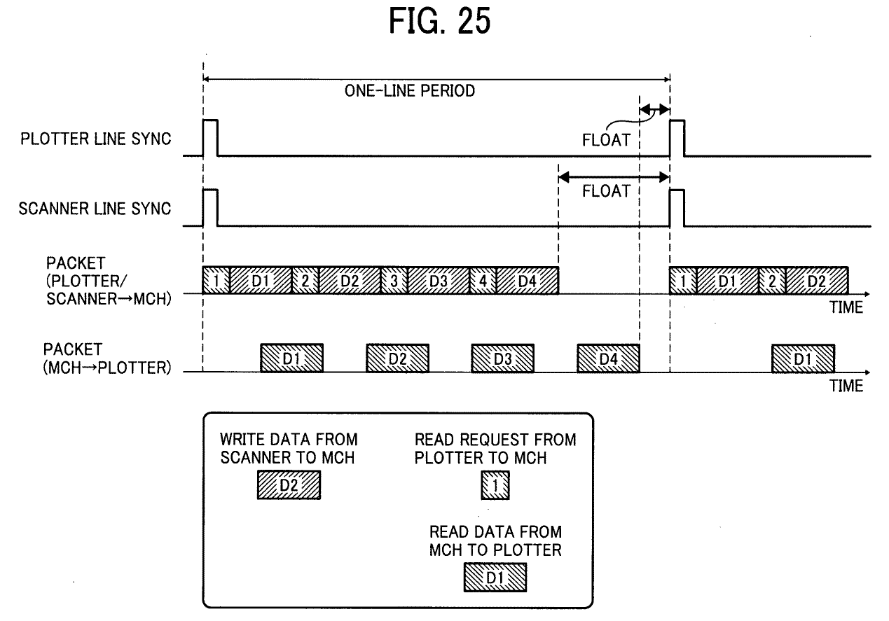

### DETAILED DESCRIPTION OF THE PREFERRED EMBODIMENTS

Exemplary embodiments of an image forming apparatus according to the present invention are explained in detail below with reference to the accompanying drawings.

In a first embodiment, the image forming apparatus is, for example, a digital copier or a multi function peripheral (MFP), in which PCIe is used as an internal interface.

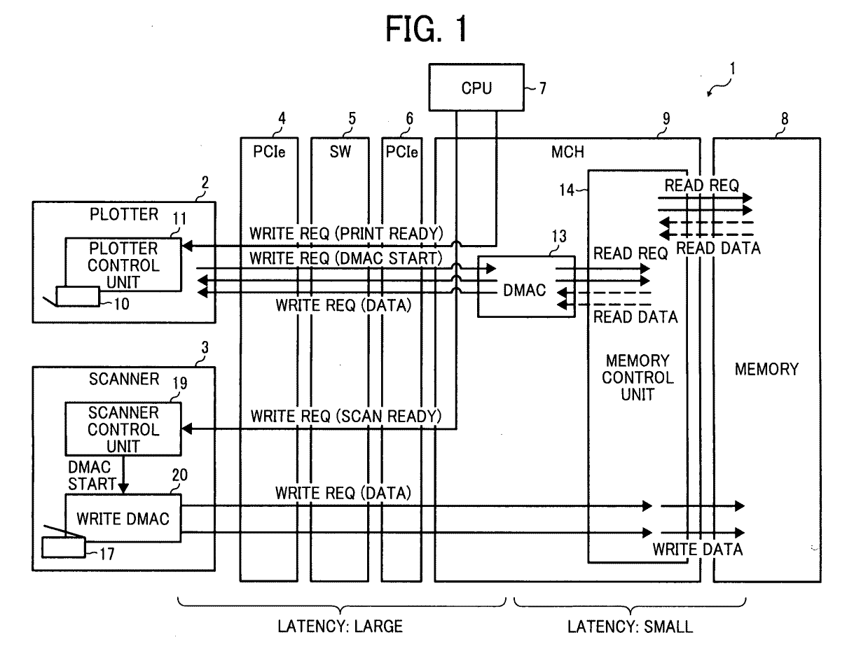

FIG. 1 is a block diagram illustrating a configuration and flow of data transfer in an image forming apparatus 1 according to the first embodiment of the present invention. The image forming apparatus 1 includes a plotter 2 that functions as an image forming unit that prints (outputs) an image on a recording sheet, such as a paper sheet, and a scanner 3 that acquires image data by photoelectrically scanning an image on an original. The plotter 2 and the scanner 3 are connected to an MCH 9 via PCIes 4 and 6 and a SW 5. The MCH 9 functions as a memory control unit that controls a memory 8 storing therein image data. The MCH 9 is connected to a CPU 7 and the memory 8 via a local bus. The CPU 7 controls the entire image forming apparatus 1 in accordance with computer programs (software) installed in the memory 8.

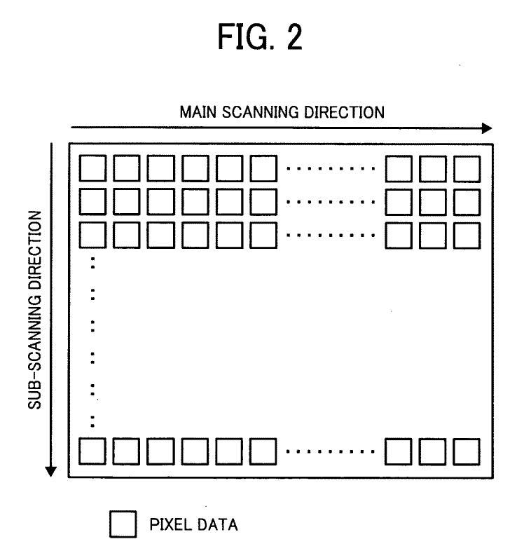

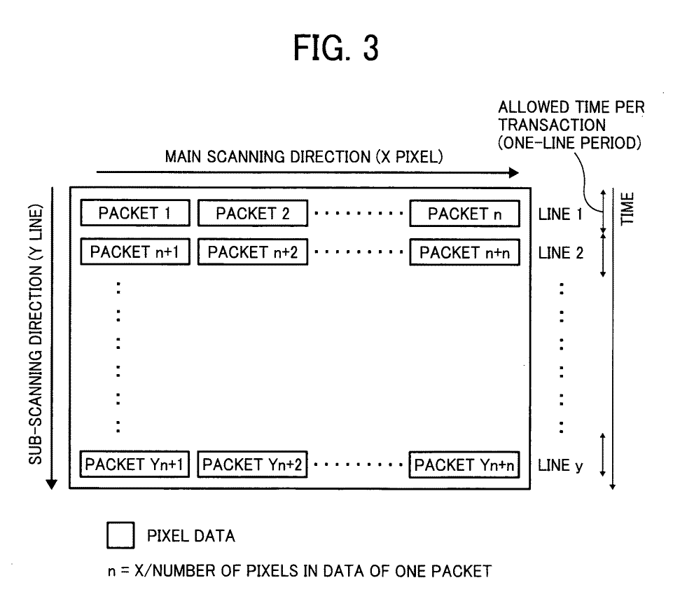

Image data employed in the image forming apparatus 1 is in the form of a two-dimensional array in main scanning and sub-scanning directions as shown in FIG. 2. Transfer of image data to the plotter 2 or from the scanner 3 is performed by a synchronous transfer in which a process of transferring pixel data in the main-scanning direction with a predetermined time period is repeated in the sub-scanning direction. As shown in FIG. 3, data needs to be transferred as a transaction consisting of a plurality of packet groups (n packet groups in FIG. 3) for each line with a plurality of pieces of pixel data as one piece of packet data for every line in the main-scanning direction in synchronization with the speed of scanning an image in the sub-scanning direction. An allowed time per transaction in FIG. 3 is called a one-line period. A one-line period T2 of the plotter 2 is determined in accordance with a sheet feeding speed and a resolution of a print image, and a one-line period T3 of the scanner 3 is determined in accordance with a moving speed and an optical resolution of a scanner unit 17. The one-line periods T2 and T3 are, for example, expressed by the following equations:

T2(second (s))=1/{(sheet feeding speed (mm/s))×(number of pixels per millimeter (mm))}

T3(s)=1/{(head moving speed (mm/s))×(number of pixels per mm))}

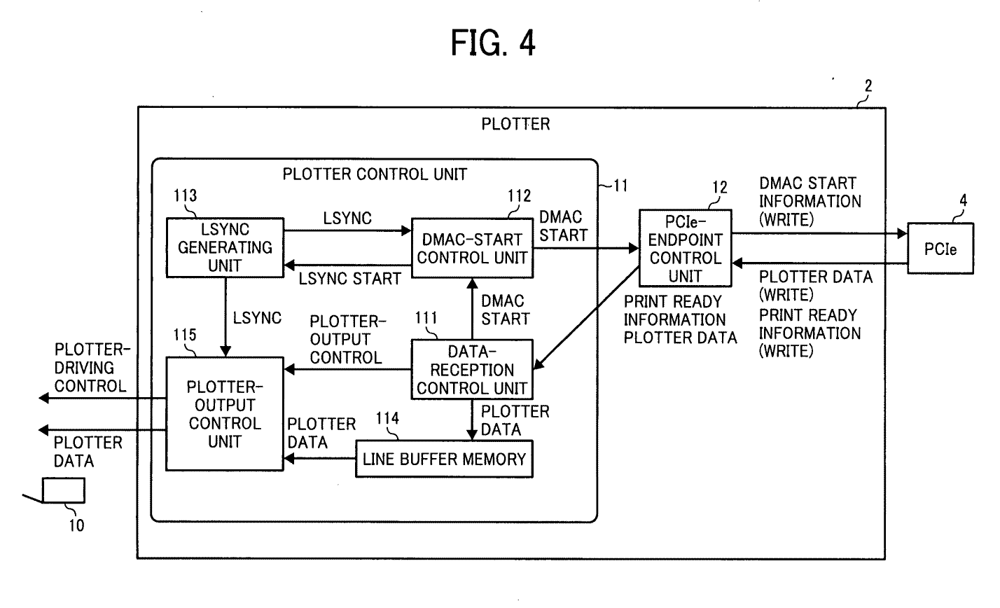

As shown in FIG. 4, the plotter 2 includes, for example, an electrophotographic plotter unit 10, a plotter control unit 11 that controls the plotter unit 10, and a PCIe-endpoint control unit 12.

The plotter unit 10 receives a plotter-driving control signal and plotter data from the plotter control unit 11 and prints the plotter data on a recording sheet in accordance with a writing resolution in synchronization with the sheet feeding speed.

The PCIe-endpoint control unit 12 receives direct memory access controller (DMAC) start information, and generates and transmits a write request packet of PCIe to a PCIe transmission path (PCIe 4 to SW 5 to PCIe 6). Moreover, the PCIe-endpoint control unit 12 receives a memory write request that is a type of a posted request as a request that does not need a response from a request transmission destination from the PCIe transmission path, and transmits print ready information and plotter data to the plotter control unit 11 in accordance with data of a packet.

The plotter control unit 11 includes a data-reception control unit 111, a DMAC-start control unit 112, a line-sync-signal (Lsync) generating unit 113, a line buffer memory 114, and a plotter-output control unit 115.

An operation of the plotter 2 is explained below. First, the PCIe-endpoint control unit 12 receives print ready information by the memory write request from a PCIe transmission path (PCIe 6 to SW 5 to PCIe 4). The PCIe-endpoint control unit 12 transmits the print ready information to the plotter control unit 11.

The data-reception control unit 111 that receives the print ready information from the PCIe-endpoint control unit 12 notifies the DMAC-start control unit 112 of a DMAC start signal.

The DMAC-start control unit 112 that receives the notification outputs an Lsync start signal to the Lsync generating unit 113.

The Lsync generating unit 113 that receives the Lsync start signal starts outputting an Lsync to the DMAC-start control unit 112 and the plotter-output control unit 115 for each period of an output line.

The DMAC-start control unit 112 that receives the Lsync outputs DMAC start information to the PCIe-endpoint control unit 12.

The PCIe-endpoint control unit 12 that receives the DMAC start information transmits a memory write packet, in which the DMAC start information is included in a data field, to the PCIe transmission path (PCIe 4 to SW 5 to PCIe 6).

Then, the MCH 9 that receives the DMAC start information via the PCIe transmission path (PCIe 4 to SW 5 to PCIe 6) starts a DMAC 13, and plotter data is transmitted to the PCIe-endpoint control unit 12 by the memory write request from the PCIe transmission path (PCIe 6 to SW 5 to PCIe 4).

The PCIe-endpoint control unit 12 transfers the plotter data included in the memory write request to the data-reception control unit 111, and the data-reception control unit 111 stores the received plotter data in the line buffer memory 114.

When an amount of the plotter data stored in the line buffer memory 114 reaches the data amount for one line of a print image, the data-reception control unit 111 outputs a plotter-output control signal to the plotter-output control unit 115.

The plotter-output control unit 115 that receives the plotter-output control signal reads out the plotter data for one line from the line buffer memory 114 and outputs a plotter-driving control signal and the plotter data to the plotter unit 10, thereby printing data for one line.

The above operation is repeated in synchronization with the Lsync, so that data for one page is printed.

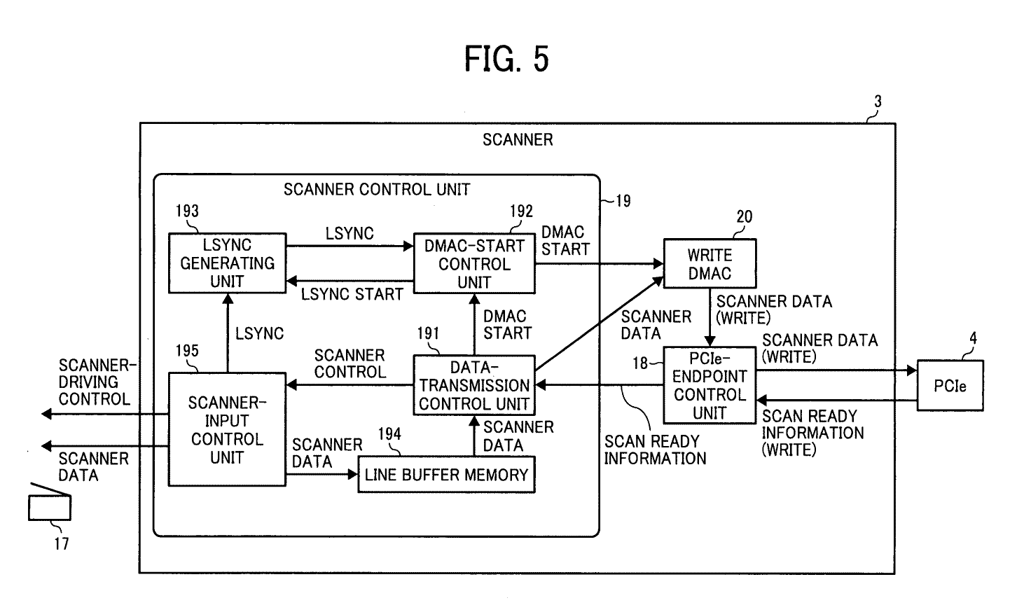

As shown in FIG. 5, the scanner 3 includes the scanner unit 17, a scanner control unit 19 that controls the scanner unit 17, a write DMAC 20, and a PCIe-endpoint control unit 18.

The scanner unit 17 receives a scanner-driving control signal from the scanner control unit 19 and outputs scanner data, which is scanned in accordance with an optical resolution in synchronization with the moving speed of a scanner head, to the scanner control unit 19.

The write DMAC 20 receives a DMAC start information signal and the scanner data from the scanner control unit 19 and transfers the scanner data to the PCIe-endpoint control unit 18.

The PCIe-endpoint control unit 18 receives a memory write request from the PCIe transmission path (PCIe 6 to SW 5 to PCIe 4), extracts scan ready information from a data field of the memory write request, and notifies the scanner control unit 19 of the scan ready information. Moreover, the PCIe-endpoint control unit 18 receives the scan data from the write DMAC 20 and transmits a packet of the memory write request, in which the scanner data is included in the data field, to the PCIe transmission path (PCIe 4 to SW 5 to PCIe 6).

The scanner control unit 19 includes a data-transmission control unit 191, a DMAC-start control unit 192, an Lsync generating unit 193, a line buffer memory 194, and a scanner-input control unit 195.

An operation of the scanner 3 is explained below. First, the PCIe-endpoint control unit 18 receives the scan ready information by the memory write request from the PCIe transmission path (PCIe 6 to SW 5 to PCIe 4). The PCIe-endpoint control unit 18 transmits the scan ready information to the scanner control unit 19.

The data-transmission control unit 191 receives the scan ready information from the PCIe-endpoint control unit 18 and notifies the DMAC-start control unit 192 of a DMAC start signal.

The DMAC-start control unit 192 that receives the notification outputs an Lsync start signal to the Lsync generating unit 193.

The Lsync generating unit 193 that receives the Lsync start signal starts outputting an Lsync to the DMAC-start control unit 192 and the scanner-input control unit 195 for each period of an output line.

The data-transmission control unit 191 outputs a scanner control signal to the scanner-input control unit 195.

When the scanner-input control unit 195 receives the scanner control signal and the Lsync, the scanner-input control unit 195 outputs the scanner-driving control signal to the scanner unit 17. The scanner unit 17 moves the scanner head in synchronization with the Lsync and transfers the scanner data for one line from an original to the data-transmission control unit 191. The scanner data transferred to the data-transmission control unit 191 is further stored in the line buffer memory 194.

Then, the DMAC-start control unit 192 that receives the Lsync outputs a DMAC-start control signal to the write DMAC 20.

The write DMAC 20 inputs the scanner data transferred to the data-transmission control unit 191 from the line buffer memory 194 and further outputs it to the PCIe-endpoint control unit 18.

The PCIe-endpoint control unit 18 that receives the scanner data transmits a packet of the memory write packet, in which the scanner data is included in a data field, to the PCIe transmission path (PCIe 4 to SW 5 to PCIe 6). The transmitted data is stored in the memory 8 via the MCH 9.

The above operation is repeated in synchronization with the Lsync. By repeating the data transfer operation for one line, data for one page is scanned to be stored in the memory 8.

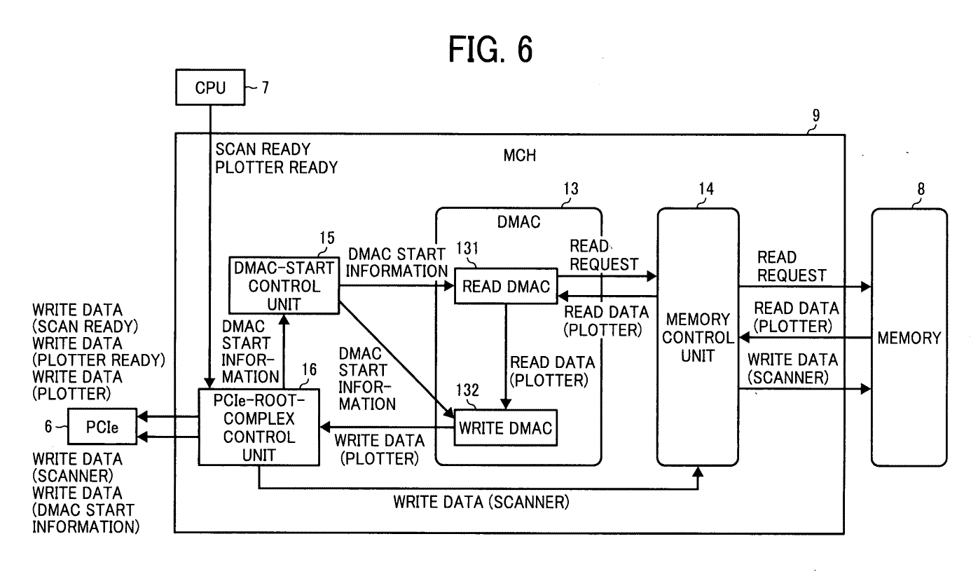

As shown in FIG. 6, the MCH 9 includes the DMAC 13, a memory control unit 14, a DMAC-start control unit 15, and a PCIe-root-complex control unit 16.

The PCIe-root-complex control unit 16 receives plotter ready information and scan ready information from the CPU 7 connected to the MCH 9, inserts them in a data field of a memory-write request packet, and transmits the memory-write request packet to the PCIe transmission path (PCIe 6 to SW 5 to PCIe 4). Moreover, the PCIe-root-complex control unit 16 receives plotter data from the DMAC 13, stores the plotter data in the data field of the memory-write request packet, and transmits the memory-write request packet to the PCIe transmission path (PCIe 6 to SW 5 to PCIe 4). Furthermore, the PCIe-root-complex control unit 16 receives the memory-write request packet from the PCIe transmission path (PCIe 4 to SW 5 to PCIe 6). When the information in the data field of the memory-write request packet is the DMAC start information, the PCIe-root-complex control unit 16 notifies the DMAC-start control unit 15 of the information. When the information in the data field of the memory-write request packet is the scanner data, the PCIe-root-complex control unit 16 transfers the scanner data to the memory control unit 14.

The DMAC-start control unit 15 receives the DMAC start information from the PCIe-root-complex control unit 16 and transfers it to the DMAC 13.

The DMAC 13 includes a read DMAC 131 and a write DMAC 132. When the read DMAC 131 receives the DMAC start information, the read DMAC 131 notifies the memory control unit 14 of the memory read request and transfers read data received from the memory control unit 14 to the write DMAC 132. The write DMAC 132 that receives the data from the read DMAC 131 transfers the data to the PCIe-root-complex control unit 16.

An operation of the MCH 9 is explained below. First, a plotter-data transfer operation is explained. In the plotter-data transfer operation, first, plotter ready information is input to the PCIe-root-complex control unit 16 from the CPU 7, which is transmitted to the PCIe transmission path (PCIe 6 to SW 5 to PCIe 4) as a memory write request.

The plotter 2 that receives the plotter ready information transfers DMAC start information to the PCIe-root-complex control unit 16 by the memory write request via the PCIe transmission path (PCIe 4 to SW 5 to PCIe 6).

Then, the PCIe-root-complex control unit 16 transfers the DMAC start information to the DMAC-start control unit 15, so that the read DMAC 131 is started.

The read DMAC 131 notifies the memory control unit 14 of a memory read request, and the memory control unit 14 notifies the memory 8 of the memory read request. The memory 8 responds to the memory control unit 14 with plotter data as read data.

The memory control unit 14 transfers the read data (plotter data) to the read DMAC 131, and the read data is then transferred to the write DMAC 132.

The write DMAC 132 that receives the plotter data transfers it as write data to the PCIe-root-complex control unit 16, and the PCIe-root-complex control unit 16 stores the plotter data in a data field of the memory write request and transmits the memory write request to the PCIe transmission path (PCIe 6 to SW 5 to PCIe 4). With the above operation, the plotter data is transferred from the MCH 9 to the plotter 2.

A scanner-data transfer operation is explained below. In the scanner-data transfer operation, first, scan ready information is input to the PCIe-root-complex control unit 16 from the CPU 7, which is transmitted to the PCIe transmission path (PCIe 6 to SW 5 to PCIe 4) as a memory write request.

The scanner 3 that receives the scan ready information transfers scanner data to the PCIe-root-complex control unit 16 by the memory write request via the PCIe transmission path (PCIe 4 to SW 5 to PCIe 6).

The scanner data is transferred from the PCIe-root-complex control unit 16 to the memory control unit 14 as write data, and the memory control unit 14 notifies the memory 8 of the memory write request to store the memory write data in the memory 8. With the above operation, the scanner data is transferred from the scanner 3 to the MCH 9 and is further stored in the memory 8.

The plotter-data transfer operation and the scanner-data transfer operation are explained individually; however, the image forming apparatus in the present embodiment can perform the above operations in parallel simultaneously, so that the image printing and the image scanning can be performed simultaneously.

Various data transfers, which are performed in the image forming apparatus having the above-explained configuration under the control of the CPU 7, are explained.

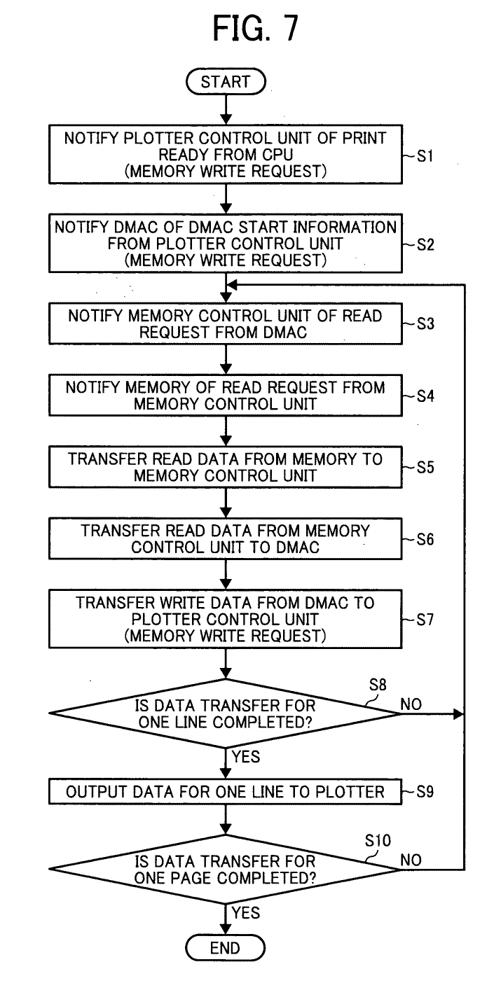

An operation of printing image data stored in the memory 8 by the plotter 2 is explained below with reference to a flowchart shown in FIG. 7.

As shown in FIG. 7, first, the CPU 7 notifies the plotter control unit 11 to get ready for performing printing. Specifically, the CPU 7 sends print ready information to the plotter control unit 11 by a memory write request packet via the MCH 9 and the PCIe transmission path (PCIe 6 to SW 5 to PCIe 4) (Step S1).

Then, the plotter control unit 11 notifies the DMAC 13 of DMAC start information by the memory write request packet via the PCIe transmission path (PCIe 4 to SW 5 to PCIe 6) (Step S2).

At Step S3, the DMAC 13 is started and it notifies the memory control unit 14 of a read request to request a memory read transfer.

At Step S4, the memory control unit 14 requests data transfer to the memory 8 by the read request.

At Step S5, the read data corresponding to the read request is transferred from the memory 8 to the memory control unit 14.

At Step S6, the read data corresponding to the memory read request is transferred from the memory control unit 14 to the DMAC 13.

At Step S7, a plotter data packet (write data) is transferred from the DMAC 13 to the plotter control unit 11 by a memory write request via the PCIe transmission path (PCIe 6 to SW 5 to PCIe 4).

The processes from Step S3 to Step S7 are repeated until completing the data transfer for one line (Yes at Step S8).

When the data transfer for one line is completed (Yes at Step S8), the data for one line is output to the plotter 2 (Step S9).

The processes from Step S3 to Step S9 are repeated until completion of the data transfer for one page (Yes at Step S10).

When the data for one page stored in the memory 8 is transferred to the plotter 2 in this manner, the plotter 2 prints an image on a recording sheet.

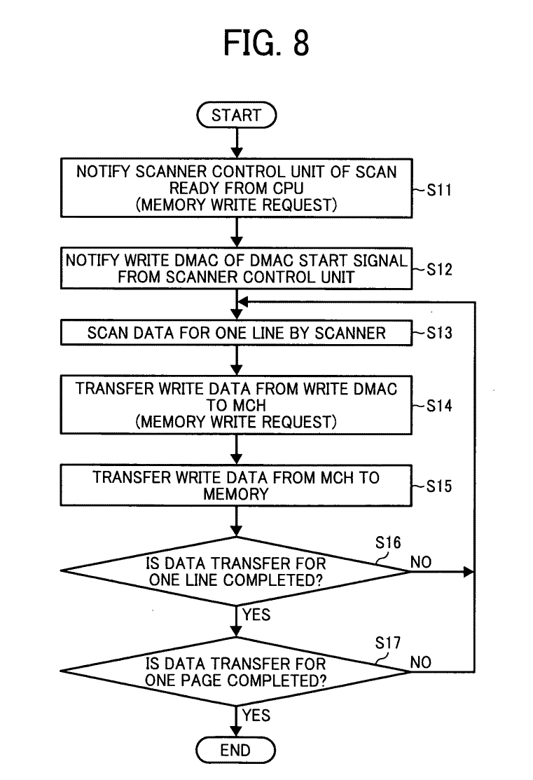

An operation of storing image data scanned by the scanner 3 in the memory 8 is explained below with reference to a flowchart shown in FIG. 8.

As shown in FIG. 8, first, the CPU 7 notifies the scanner control unit 19 to get ready for performing scanning. Specifically, the CPU 7 sends scan ready information to the scanner control unit 19 by a memory write request packet via the MCH 9 and the PCIe transmission path (PCIe 6 to SW 5 to PCIe 4) (Step S11).

Then, the scanner control unit 19 notifies the write DMAC 20 of a DMAC start signal to start the write DMAC 20 (Step S12).

When the data for one line is scanned by the scanner unit 17 (Step S13), the write DMAC 20 transfers the write data scanned by the scanner unit 17 to the memory control unit 14 by the memory write request packet via the PCIe transmission path (PCIe 4 to SW 5 to PCIe 6) (Step S14).

At Step S15, the memory control unit 14 transfers the write data to the memory 8 by the memory write request.

The processes from Step S13 to Step S15 are repeated until completion of the data transfer for one line (Yes at Step S16).

The processes from Step S13 to Step S16 are repeated until completion of the data transfer for one page (Yes at Step S17).

The image data scanned by the scanner 3 in the above manner is stored in the memory 8.

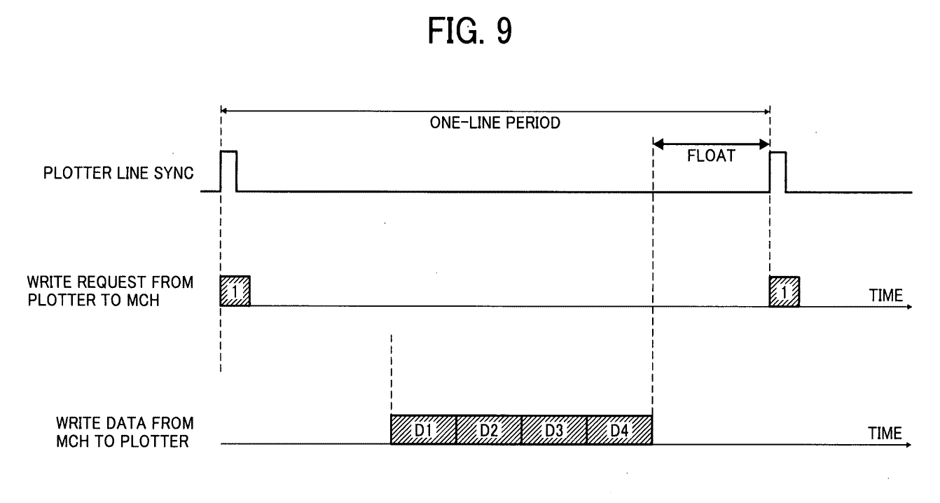

FIG. 9 is a timing chart of an operation when transferring plotter data. In the following explanation, it is assumed that data for one line is transferred in four packets for simplifying the explanation. The data transfer by the plotter is synchronized with the plotter line sync (one-line period). As shown in FIG. 9, a memory write request (DMAC start information) from the plotter 2 to the MCH 9 is issued in synchronization with the plotter line sync, and the data transfer from the MCH 9 to the plotter 2 is processed by continuous memory write requests. As a result, float to the line period can be made longer without transmitting a plurality of data transfer requests from the plotter 2 to the MCH 9 in the split method.

A printing performance of the image forming apparatus 1 is represented in terms of a printing speed and a print resolution and the printing performance of the image forming apparatus 1 is compared with that of a conventional image forming apparatus. For simplifying the calculation, the print resolution of the plotter 2 is assumed to be 1000 dots/mm in both of the main and sub scanning directions, and the number of bits of each pixel is 1 bit assuming monochrome printing. Moreover, a size of an original is 297 mm in the main-scanning direction and 210 mm in the sub-scanning direction assuming that an A4 landscape sheet is used. The bandwidth of PCIe is 1 GB/sec assuming a 4-lane connection.

The image data in one line in the main-scanning direction is 297000 bits (=1000 dots/mm×297 mm×1 bit), which is 37125 bytes (=297000 bits/8 bits) in units of bytes.

Assuming that data for one line is transferred by dividing the data into packets of 128 bytes, data containing about 291 packets (≈37125/128) needs to be transferred within one-line period.

Assuming that the latency from the time the plotter issues a read request to the time image data is returned is 1 microsecond (μs), when the split number is one in the conventional image forming apparatus, the data transfer for one packet is performed in 1 μs, so that it takes 291 μs to transmit 291 packets for one line. When the split number is two, the data for two packets is transferred in 1 μs, so that it takes 145.5 μs to transmit 291 packets for one line. In the same manner, when the split number is four, it takes 72.75 μs to transmit 291 packets for one line.

In the image forming apparatus 1, continuous memory write requests are issued from the memory 8, so that the data transfer can be always performed at the bandwidth of 1 GB/sec that is near the upper limit of PCIe. Data for 291 packets is transferred in 37.125 μs.

The printing speed of the image forming apparatus 1 is compared with that of a conventional image forming apparatus in which the split number is four. In the conventional image forming apparatus, it takes 72.75 μs to transfer data for one line, which is the limit value in one-line period. The print resolution is 1000 dots/mm, and the size of an original is 210 mm in the sub-scanning direction, so that an image on one page is formed by 210000 lines (=210 mm×1000 dots). Because the one-line period is 72.75 μs, the printing time for one page is 15.2775 s (=72.75 μs×210000 lines), i.e., the printing speed is 3.93 sheets/min (≈60 s/15.2775 s).

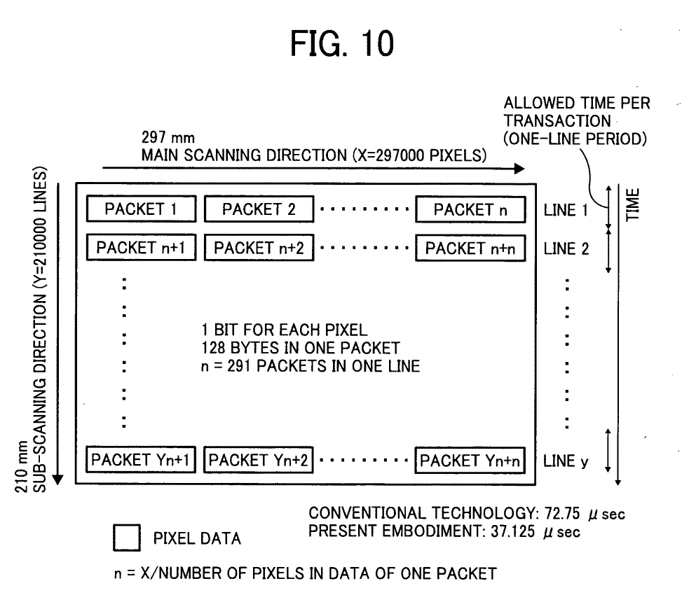

In the image forming apparatus 1, it takes 37.125 μs to transfer data for one line, so that the printing time for one page is 7.79625 s (=37.125 μs×210000 lines), i.e., the printing speed is 7.7 sheets/min (≈60 s/7.79625 s). Thus, the printing time is about twice of that in the conventional image forming apparatus. The printing conditions used in the above calculation example are shown in FIG. 10.

In the above example, the print resolution is set to 1000 dots/mm in the main-scanning direction, in the next example, however, the printing speed is fixed to 3.93 sheets/min for evaluating the performance in print resolution in the main-scanning direction. The print resolution in the sub-scanning direction is set to 1000 dots/mm for simplifying the calculation.

When the printing speed is 3.93 sheets/min, the one-line period is 72.75 μs as in the above calculation example in the conventional image forming apparatus. The conventional image forming apparatus reaches the limit performance when the print resolution in the main-scanning direction is 1000 dots/mm; however, because the image forming apparatus 1 can transfer data at 1 GB/sec, data of 72750 bytes (=582000 bits) can be transferred in 72.75 μs that is the one-line period.

Because the size of the original is 297 mm in the main-scanning direction, printing can be performed with the print resolution of 1959 dots/mm (≈582000 bits/297 mm), which is about twice of the limit value (1000 dots/mm) in the conventional image forming apparatus.

Accordingly, under the condition that the latency from the time a read request is issued to the time image data is returned is 1 μs, at least, the split number needs to be set to 8 in the conventional image forming apparatus to have a performance equivalent to the image forming apparatus 1. Even when the split number is set to 8 in the conventional image forming apparatus, a buffer memory for holding eight read data packets of 128 bytes needs to be provided at each unit, such as a DMAC, a PCIe-endpoint control unit, a PCIe-root-complex control unit, and a SW port, which results in increasing the size and the cost of a circuit.

Moreover, if two or more plotters are connected to a PCIe switch, or other optional devices or switches are connected, the latency increases. In this case, even if the split number is set to 8, the data transfer performance may be insufficient. If the latency becomes 2 μs, the split number needs to be increased to 16.

Therefore, in the conventional image forming apparatus, it is difficult to design the split number appropriate for using the memory read transfer and cost of a circuit increases. However, in the image forming apparatus 1, the maximum data transfer bandwidth can be always obtained without being influenced by the change in latency due to change of a data transmission path or addition of an expansion device, thereby realizing high printing speed and print resolution at low cost.

According to the first embodiment, image data for one page is transferred by the plotter 2 repeating a process of standing by until the next line synchronization timing after data transfer for one line and transferring DMAC control information requesting data transfer for one line to the MCH 9 for each line synchronization timing. Therefore, data transfer from the MCH 9 to the plotter 2 is processed by continuous posted requests, so that the float to the line period can be made long without transmitting a plurality of data transfer requests from the plotter 2 to the MCH 9 in the split method. Thus, a high data transfer performance can be realized with a circuit that is low in cost because the cost for mounting a buffer memory or the like on the circuit is not needed.

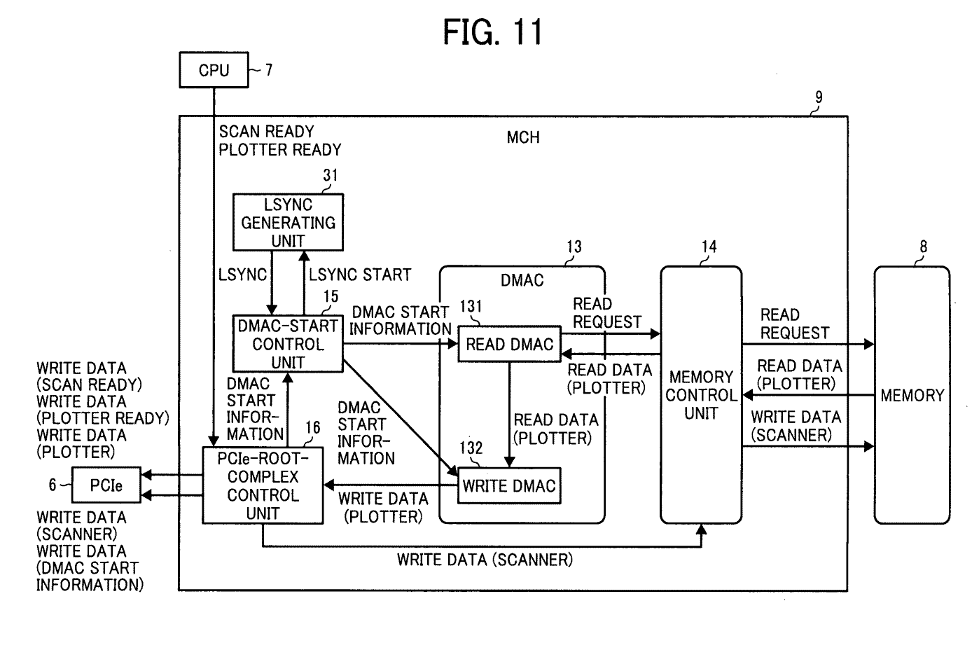

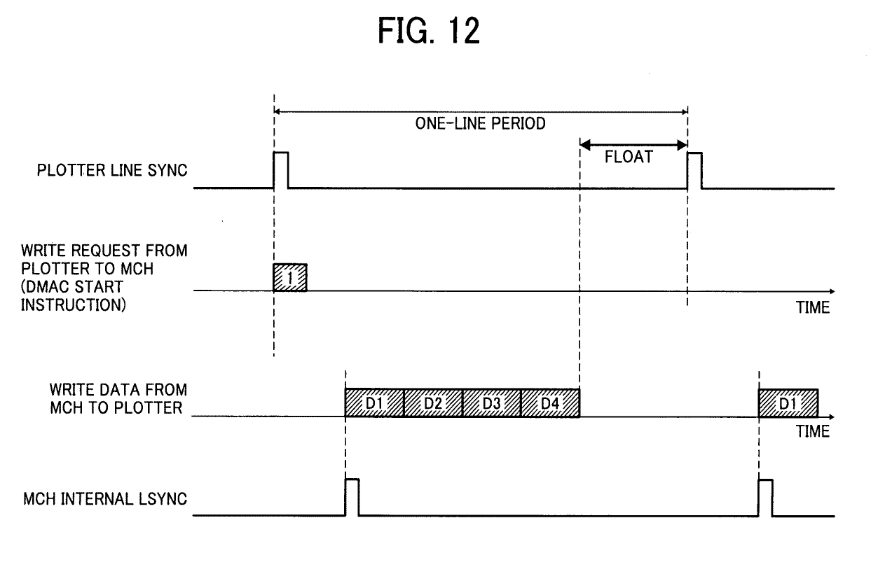

A second embodiment is explained below with reference to FIGS. 11 and 12. Components that are the same as those in the first embodiment will be given the same reference numerals and explanation thereof is omitted.

The configuration of a plotter in the second embodiment is the same as the plotter 2 shown in FIG. 4; however, the operation of the DMAC-start control unit 112 is different from that in the first embodiment.

The DMAC-start control unit 112 outputs DMAC start information to the PCIe-endpoint control unit 12 only once when the DMAC-start control unit 112 receives an Lsync for the first time from the Lsync generating unit 113 without outputting the DMAC start information for every reception of the Lsync.

Moreover, the operation of the DMAC-start control unit 15 is different from that in the first embodiment.

FIG. 11 is a block diagram illustrating an internal configuration and an operation of the MCH 9 according to the second embodiment. As shown in FIG. 11, the MCH 9 includes an Lsync generating unit 31.

With this configuration, when the DMAC-start control unit 15 receives DMAC start information from the PCIe-root-complex control unit 16, the DMAC-start control unit 15 transmits an Lsync start signal to the Lsync generating unit 31.

The Lsync generating unit 31 that receives the Lsync start signal outputs the Lsync with a period same as a plotter line period in the plotter 2.

The DMAC-start control unit 15 outputs DMAC-start control information to the DMAC 13 at a timing at which the Lsync is input.

FIG. 12 is a timing chart of the operation when transferring the plotter data in the second embodiment. It is assumed that data for one line is transferred in four packets for simplifying the explanation. A write request from the plotter 2 to the MCH 9 is transmitted at a timing of a plotter line sync of the first line. Write data (plotter data) from the MCH 9 to the plotter 2 is transferred continuously from the MCH 9 to the plotter 2 in the similar manner to the first embodiment. However, from the second line, the write data from the MCH 9 to the plotter 2 is transmitted at timing in synchronization with the Lsync generated by the Lsync generating unit 31, which is different from the first embodiment.

According to the second embodiment, when the DMAC 13 receives DMAC control data from the plotter control unit 11, a process of generating a line synchronization timing with a time period that is allowed in the-data transfer for one line of a print image in the main-scanning direction, stopping the data transfer until the next line synchronization timing after the data transfer for one line, and resuming the data transfer for each line synchronization timing, is repeated, to transfer image data for one page. Therefore, even when the latency in memory-write packet transfer from the plotter 2 to the MCH 9 fluctuates, a high-speed data transfer can be realized.

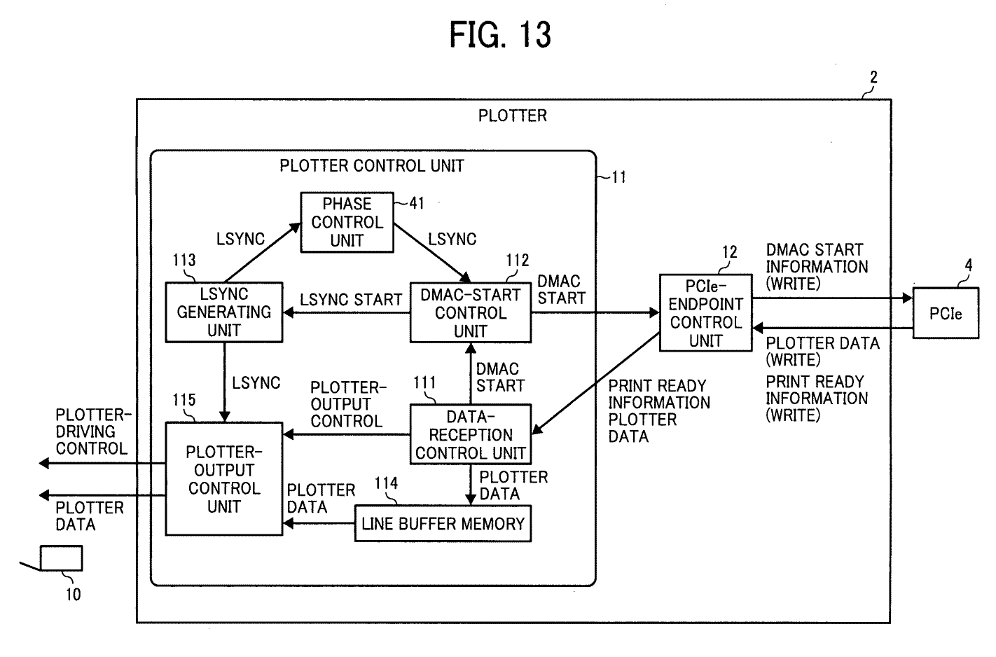

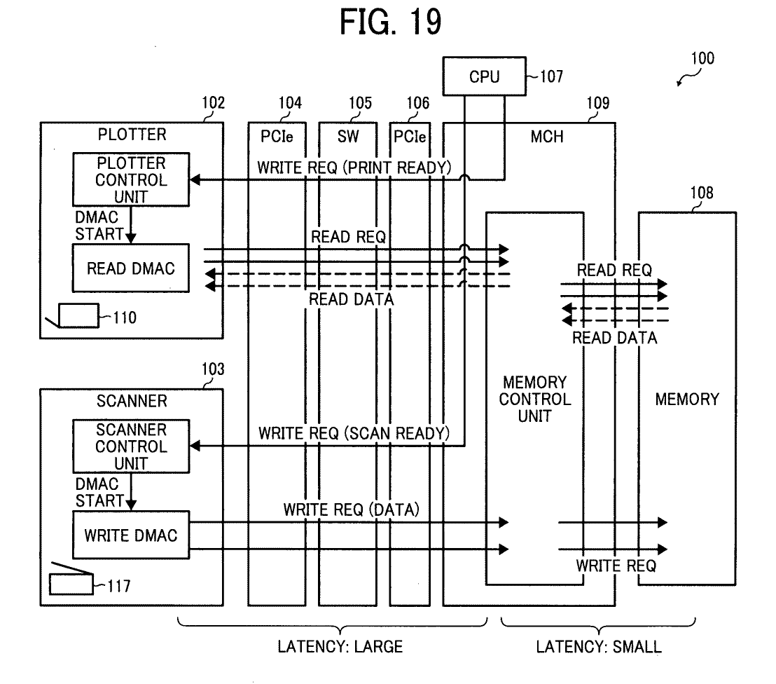

A third embodiment is explained below with reference to FIGS. 13 to 19. Components that are the same as those in the first or second embodiment will be given the same reference numerals and explanation thereof is omitted.

FIG. 13 is a block diagram illustrating an internal configuration and an operation of the MCH 9 according to the third embodiment. As shown in FIG. 13, the plotter 2 includes a phase control unit 41.

With this configuration, the phase control unit 41 shifts a phase with respect to an Lsync output from the Lsync generating unit 113 so that the timing of the Lsync is advanced by the latency needed from the time the memory write packet notifying of DMAC start information from the plotter 2 to the MCH 9 is transmitted to the time a memory write request packet of plotter data is returned from the MCH 9, and outputs the Lsync to the DMAC-start control unit 112.

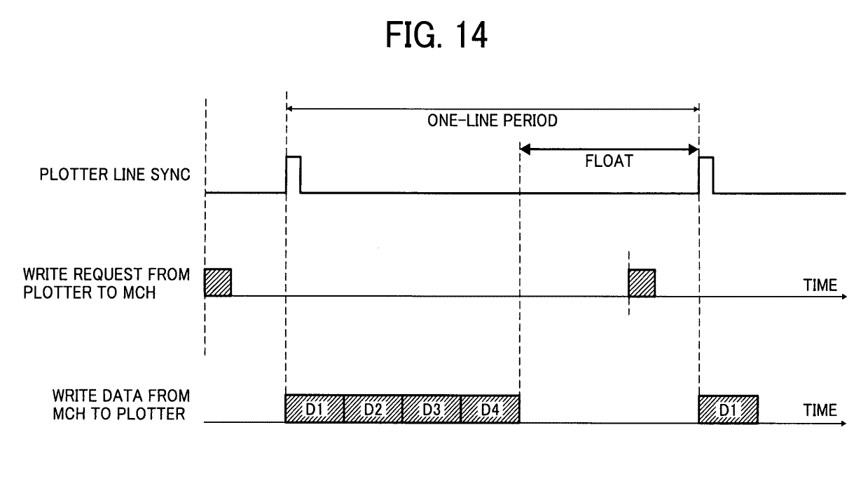

FIG. 14 is a timing chart of an operation when transferring the plotter data in the third embodiment. It is assumed that data for one line can be transferred in four packets for simplifying the explanation. The operation of transferring the plotter data becomes as shown in the timing chart in FIG. 14 by shifting a phase of a DMAC start timing ahead of a plotter line sync by the phase control unit 41.

As shown in FIG. 14, transmission of a write request to the MCH 9 from the plotter 2 is advanced by the latency needed from the time a memory write packet notifying of DMAC start information from the plotter 2 to the MCH 9 is transmitted to the time a memory write request packet of plotter data is returned from the MCH 9, and write data starts to be transferred from the MCH 9 to the plotter 2 at the timing same as the line sync of the plotter 2. Therefore, the float with respect to the plotter line sync becomes longer than that in the timing charts shown in FIG. 9 or FIG. 12, so that it is possible to be used for transferring plotter data with shorter line period or higher resolution.

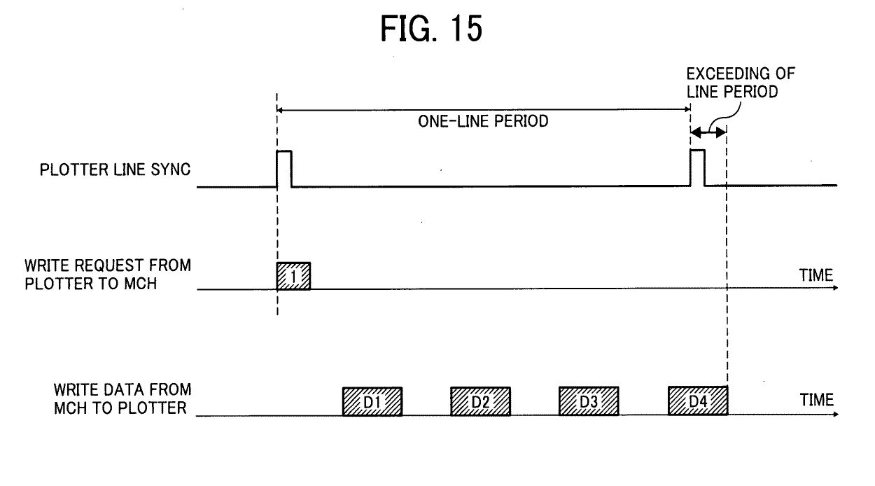

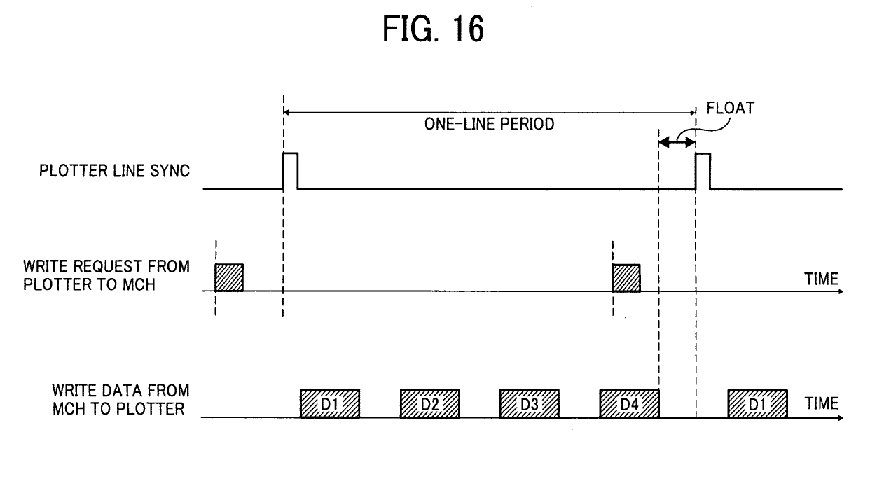

Moreover, even when data transfer rate from the MCH 9 to the plotter 2 decreases due to occurrence of competitive traffic with other devices in the SW 5 or the like in the PCIe transmission path (PCIe 4 to SW 5 to PCIe 6), or the like, exceeding of the line period is unlikely to occur. As one example, FIG. 15 depicts an operation example in which exceeding of the line period occurs due to a decrease in the write-data transfer efficiency in the image forming apparatus according to the second embodiment, and FIG. 16 depicts an operation example in which exceeding of the line period does not occur even if the write-data transfer efficiency decreases in the image forming apparatus according to the third embodiment.

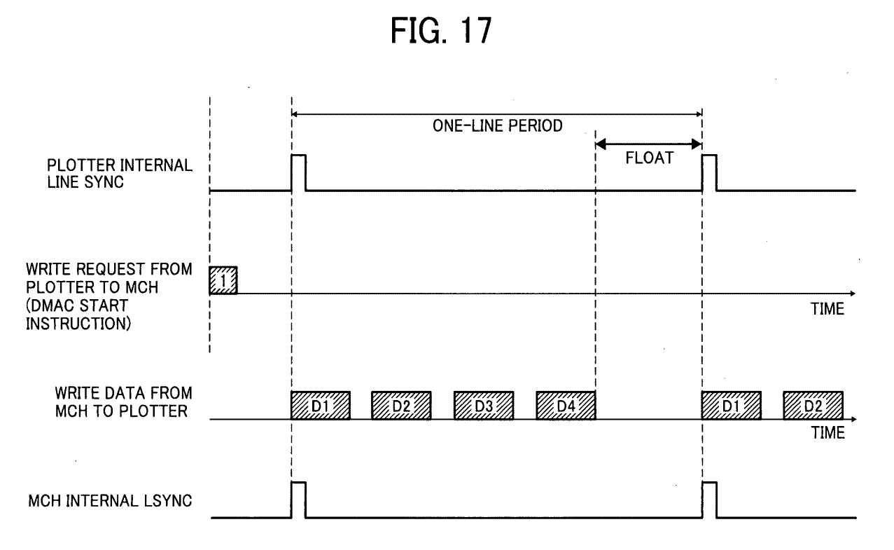

Furthermore, FIG. 17 is a timing chart of an example of the plotter data transfer when the image forming apparatuses according to the second and third embodiments are both operated. As shown in FIG. 17, because write data transfer is started in synchronization with the internal Lsync of the MCH 9, it is possible to suppress that request transfer to a write request from the plotter 2 to the MCH 9 becomes slow due to the influence of the competitive traffic in the second and succeeding lines.

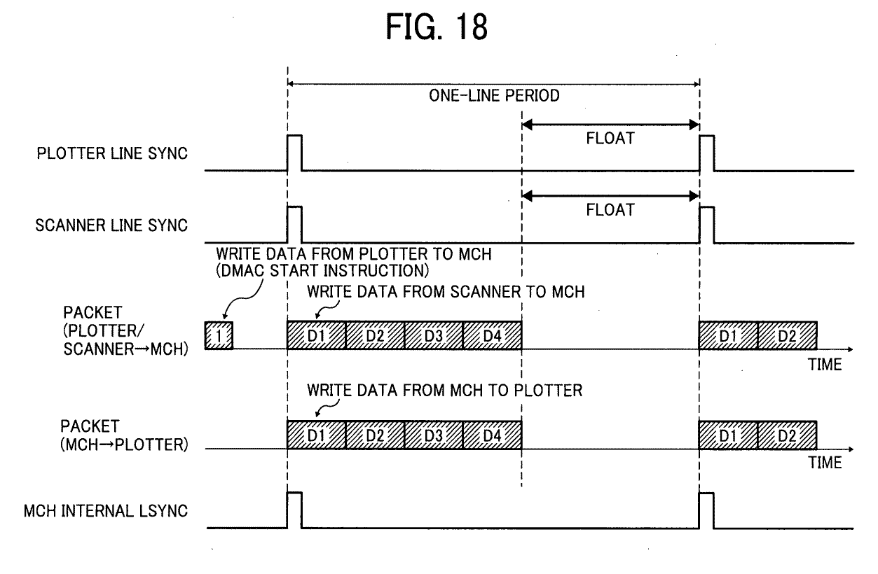

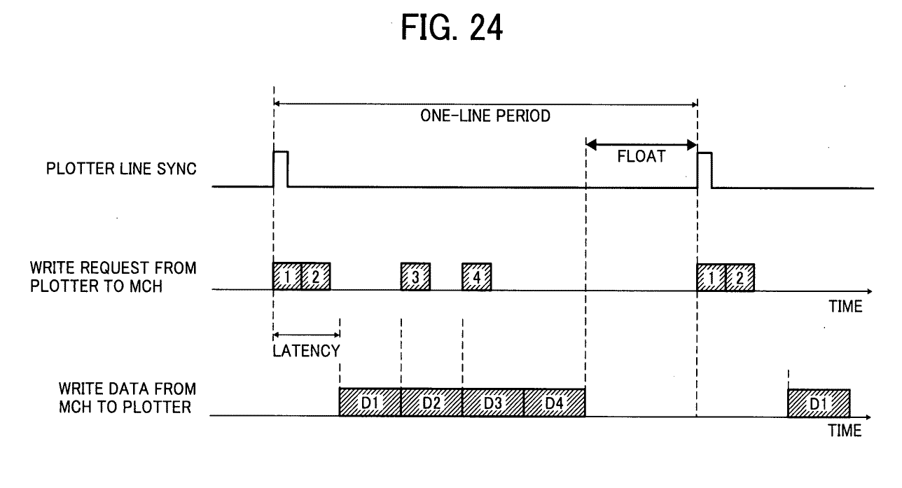

Moreover, FIG. 18 is a timing chart of an example of a concurrent operation of the plotter 2 and the scanner 3 when the image forming apparatuses according to the second and third embodiments are both operated. As shown in FIG. 18, scanner data is transferred from the scanner 3 to the MCH 9 by the memory write transfer in synchronization with an Lsync of the scanner 3, and plotter data is transferred from the MCH 9 to the plotter 2 by the memory write transfer in synchronization with an internal Lsync of the MCH 9. The float with respect to the one-line period can be increased in both of the plotter 2 and the scanner 3 compared with the operation in which the memory read transfer and the memory write transfer are mixed in the conventional image forming apparatus as shown in FIG. 24. Thus, it is possible to be applied to higher scanner reading speed or higher plotter printing speed, or printing or reading of image data with higher resolution.

According to the third embodiment, because the transmission of a write request to the MCH 9 from the plotter 2 is advanced by the latency needed from the time a memory write packet notifying of DMAC start information from the plotter 2 to the MCH 9 is transmitted to the time a memory write request packet of plotter data is returned from the MCH 9, the write data transfer from the MCH 9 to the plotter 2 starts at the same timing of a line sync of the plotter 2, and the float with respect to the line sync of the plotter 2 becomes long. Thus, it is possible to be used for transferring plotter data with shorter line period or higher resolution.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an image forming unit configured to form an image based on image data;
a memory configured to store therein the image data; and
a memory control unit configured to control data transfer between the image forming unit and the memory, wherein
the image forming unit transmits control information to the memory control unit for obtaining the image data from the memory by using a first posted request that does not need a response from a request transmission destination, and
the memory control unit transfers the image data from the memory to the image forming unit by using a second posted request upon receiving the first posted request from the image forming unit.

2. The image forming apparatus according to claim 1, wherein the image forming unit transmits the control information to the memory control unit at a certain time period, the time period being a time duration that is equal to or less than a time duration allocated for data transfer of one line of a print image in a main-scanning direction.

3. The image forming apparatus according to claim 1, wherein the image forming unit transmits the control information to the memory control unit at a timing of receiving a line synchronization signal for a first time,
the memory control unit includes a line-synchronization-signal generating unit configured to generate a line synchronization signal, and transfer the image data to the image forming unit by using the second posted request at a timing in synchronization with the line synchronization signal generated by the line-synchronization-signal generating unit upon receiving the control information from the image forming unit.

4. The image forming apparatus according to claim 1, wherein the image forming unit includes a phase control unit configured to shift a phase of a timing of outputting a line synchronization signal to advance by a time from when the control information is transmitted to the memory control unit by using the first posted request to when the memory control unit starts transferring the image data.

5. An image forming apparatus comprising:
an image forming unit configured to form an image based on image data;
a memory configured to store therein the image data;
a central processing unit configured to control the image forming apparatus as a whole;
a memory control unit that includes a direct memory access controller configured to allow data transfer between the image forming unit and the memory without intervention of the central processing unit; and
a serial transmission path that connects the memory control unit to the image forming unit, wherein
the image forming unit, when performing image formation, transmits direct memory access controller information to the memory control unit for obtaining the image data from the memory by a posted request that does not need a response from a request transmission destination by generating a line synchronization timing with a time period that is allowed in data transfer for one line of a print image in a main-scanning direction, and
the memory control unit, upon receiving the direct memory access controller information from the image forming unit, retrieves the image data from the memory, and transfers the image data to the image forming unit by the posted request via the serial transmission path.

6. The image forming apparatus according to claim 5, wherein the image forming unit outputs the direct memory access controller information to the memory control unit via the serial transmission path only once when the image forming unit receives a line synchronization signal for a first time,
the memory control unit includes a line-synchronization-signal generating unit configured to generate a line synchronization signal, and
the memory control unit, upon receiving the direct memory access controller information from the image forming unit, causes the line-synchronization-signal generating unit to generate the line synchronization signal with a period same as a line period in the image forming unit, and outputs the direct memory access controller information to the direct memory access controller in accordance with the line synchronization signal.

7. The image forming apparatus according to claim 5, wherein the image forming unit includes a phase control unit configured to shift, when performing the image formation, a phase of a timing of outputting a line synchronization signal to advance by a time from when the direct memory access controller information is transmitted to the memory control unit by using the posted request to when the image data in the memory control unit starts to be transferred for a first time and outputs the line synchronization signal.

8. A data transferring method comprising:
transmitting control information for acquiring image data stored in a memory from an image forming unit, which forms an image based on image data, to a memory control unit by using a first posted request that does not need a response from a request transmission destination; and
transferring the image data from the memory to the image forming unit by the memory control unit by using a second posted request upon receiving the first posted request transmitted at the transmitting.
